(19) United States
(12) Patent Application Publication
(10) Pub. No.: US 2001/0034664 A1
(43) Pub. Date: Oct. 25, 2001

(54) Systems and methods for performing e-commerce and communications over a network

(76) Inventor: Jonathan E. Brunson, Springlake, NC (US)

Correspondence Address: NIXON PEABODY, LLP, 8180 GREENSBORO DRIVE, SUITE 800, MCLEAN, VA, 22102, US

(21) Appl. No.: 09/789,696

(22) Filed: Feb. 22, 2001

Related U.S. Application Data
(60) Provisional application No. 60/228,806, filed on Feb. 22, 2000.

(51) Int. Cl. G06F 17/60

(52) U.S. Cl. 705/26; 705/27; 705/14

(57) ABSTRACT

Provided herein are tools for assisting a customer in locating products and/or services. An extension of these tools is the ability for a customer to communicate with other parties via a voice over the internet phone service. Specifically, through the use of, for example, advertising, kiosks can be made available to customers at regular locations throughout a geographical area, such as a shopping mall, a street comer, a building location, or the like. These kiosks would be funded, for example, by advertising which is streamed to display devices located on the kiosks. A user, upon approaching the kiosks, could enter a search criteria, such as a specific product or service request, and the kiosks would communicate with the necessary products/server databases to determine the availability, location, price, retailer, or the like, of the product/service. The customer could then, for example, use the voice-intelligent phone to contact, for example, the retailer to supplement the information provided via the kiosks.

### BACKGROUND OF THE INVENTION

1. Field of the Invention

This invention relates to electronic communication over a distributed network. In particular, this invention relates to locating specific information within a distributed network, and communication over the network.

2. Background of the Invention

Locating a product can be achieved in various ways. For example, a person can thumb through a phone book and determine companies that sell products within a particular subject area. Then, for example, with a phone call, a use can determine whether a company has a particular product in stock, the price, the availability, or the like.

Alternatively, a user can physically visit a number of companies querying them as to the availability of the desired product. Alternatively still, a user can navigate the Internet and attempt to locate product information in this manner.

### SUMMARY OF THE INVENTION

While existing systems and methods work well in general, they have a number of shortcomings. For example, often a customer may not have access to a phone, a phone book, or similar resources that allow that customer to locate a particular product. Similarly, a customer may not wish to expend personal resources in locating the desired products and/or service.

The systems and methods of this invention provide tools for assisting a customer in locating products and/or services. An extension of these tools is the ability for a customer to communicate with other parties via a voice over the internet phone service. Specifically, through the use of, for example, advertising, kiosks can be made available to customers at regular locations throughout a geographical area, such as a shopping mall, a street corner, a building location, or the like. These kiosks would be funded, for examples by advertising which is streamed to display devices located on the kiosks. A user, upon approaching the kiosks, could enter a search criteria, such as a specific product or service request, and the kiosks would communicate with the necessary products/server databases to determine the availability, location, price, retailer, or the like, of the product/service. The customer could then, for example, use the voice-intelligent phone to contact, for example, the retailer to supplement the information provided via the kiosks.

Alternatively, the kiosks can be used to access, for example, movies, news feeds, television stations, directory services, catalog services, video conferencing services, or the like, to a user.

These and other features and advantages of this invention are described in or are apparent from the following detailed description of the embodiments.

### BRIEF DESCRIPTION OF THE DRAWINGS

The embodiments of the invention will be described in detail, with reference to the following figures wherein:

FIG. 1 is a functional block diagram illustrating exemplary electronic commerce systems according to this invention;

FIG. 2 is a screen shot of an exemplary user interface in accordance with an embodiment of this invention;

FIG. 3 is a screen shot of an exemplary user interface in accordance with an embodiment of this invention;

FIG. 4 is a screen shot of an exemplary user interface in accordance with an embodiment of this invention;

FIG. 5 is a screen shot of an exemplary user interface in accordance with an embodiment of this invention;

FIG. 6 is a screen shot of an exemplary user interface in accordance with an embodiment of this invention;

FIG. 7 is a screen shot of an exemplary user interface in accordance with an embodiment of this invention;

FIG. 8 is a screen shot of an exemplary user interface in accordance with an embodiment of this invention;

FIG. 9 is a screen shot of an exemplary user interface in accordance with an embodiment of this invention;

FIG. 10 is a screen shot of an exemplary user interface in accordance with an embodiment of this invention;

FIG. 11 is a screen shot of an exemplary user interface in accordance with an embodiment of this invention;

FIG. 12 is a flow chart outlining exemplary methods for requesting information over a distributed network according to an embodiment of this invention;

FIG. 13 is an exemplary method for establishing communication over a distributed network according to an embodiment of this invention;

FIG. 14 is a flow chart illustrating an exemplary information selection scheme according to an embodiment of this invention; and

FIG. 15 illustrates an exemplary method for determining subject matter according to an exemplary embodiment of this invention.

### DETAILED DESCRIPTION OF THE INVENTION

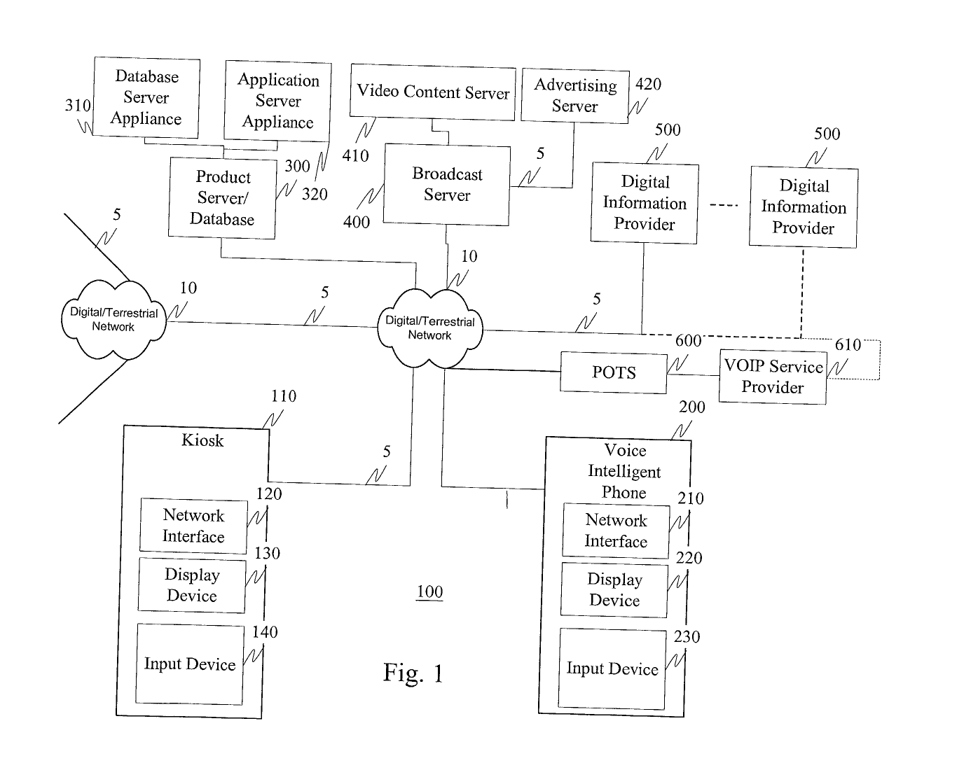

FIG. 1 illustrates an exemplary e-commerce system according to an exemplary embodiment of the invention. Specifically, the electronic commerce system 100 comprises a kiosk 110, a voice-intelligent phone 200, a product/server database 300, a broadcast server 400, and one or more digital information providers 500, all interconnected by links 5 and distributed networks 10.

The kiosk 110 comprises a network interface 120, a display device 130 and an input device 140.

The voice-intelligent phone 200 comprises a network interface 210, a display device 220 and an input device 230. The voice intelligent phone 200 is also connected to a plain old telephone system (POTS) 600, such as a digital subscriber line, a direct dial connection, or the like, and voice over Internet protocol service provider 610.

A product/server database 300 is connected to one or more database server appliances 310, an application server appliances 320. Additionally, the broadcast server 400 is connected to one or more video content servers 410 and one or more advertising servers 420.

While the exemplary embodiment illustrated in FIG. 1 shows the electronic commerce system 100 and associated components collocated, it is to be appreciated that the various components of the electronic commerce system 100 can be located at distant portions of a distributed network, such as a local area network, a wide area network, an intranet and/or the Internet, or within a dedicated electronic commerce system. Thus, it should be appreciated that the components of the electronic commerce system 100 can be combined into one or more dedicated devices or collocated on a particular node of a distributed network. As it will be appreciated from the following description, and for reasons of computational efficiency, the components of the electronic commerce system can be arranged at any location within a distributed network without affecting the operation of the system.

Furthermore, the links 5 can be a wired or wireless link or any other known or later developed element(s) that is capable of supplying and communicating electronic data to and from the connected elements. For example, the links 5 can be optical links and communications between the various components based on, for example, the TCP/IP network protocol. Additionally, the input devices 140 and 230 can be, for example, a keyboard, a mouse, a microphone, a speaker, a speech to text converter, a keypad, a digital camera or video recorder, or the like. The display devices 130 and 220 can be a computer monitor, a television, a digital display, an LCD display, or any other analog or digital device capable of displaying audio and/or video information to one or more users.

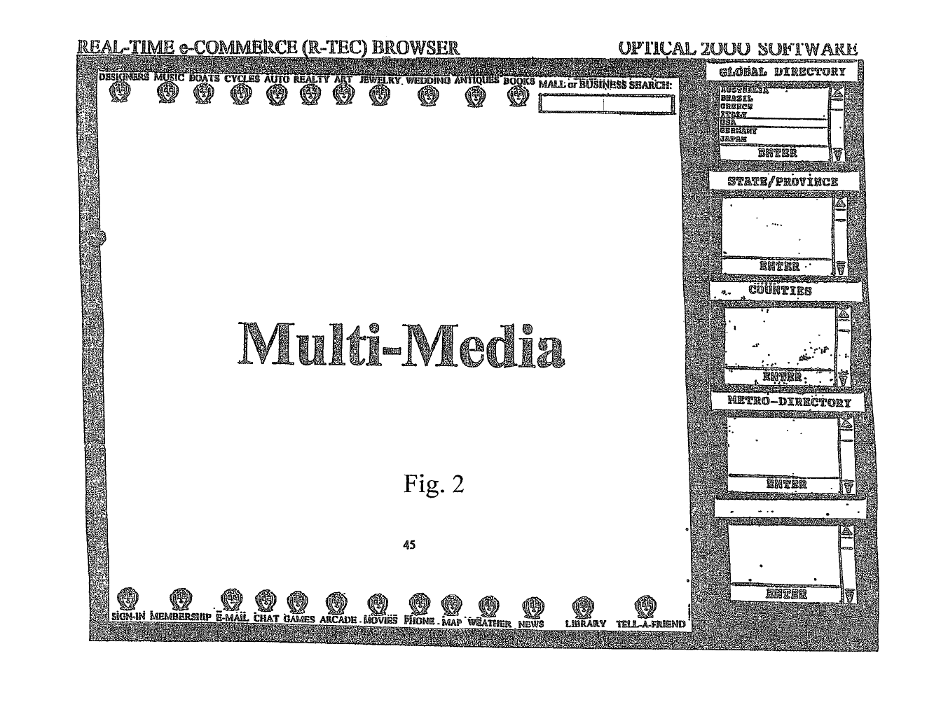

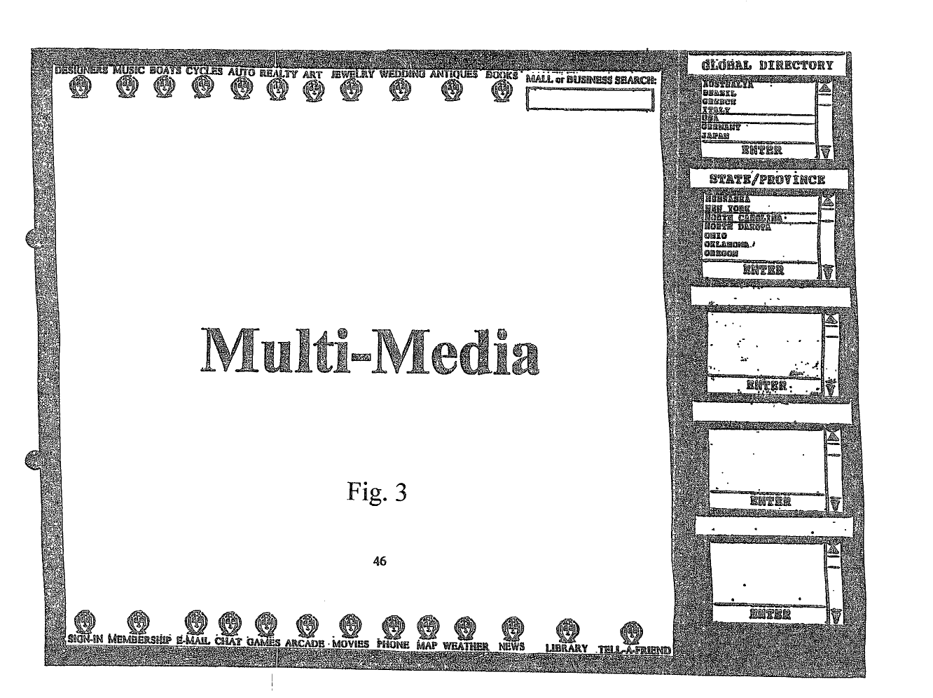

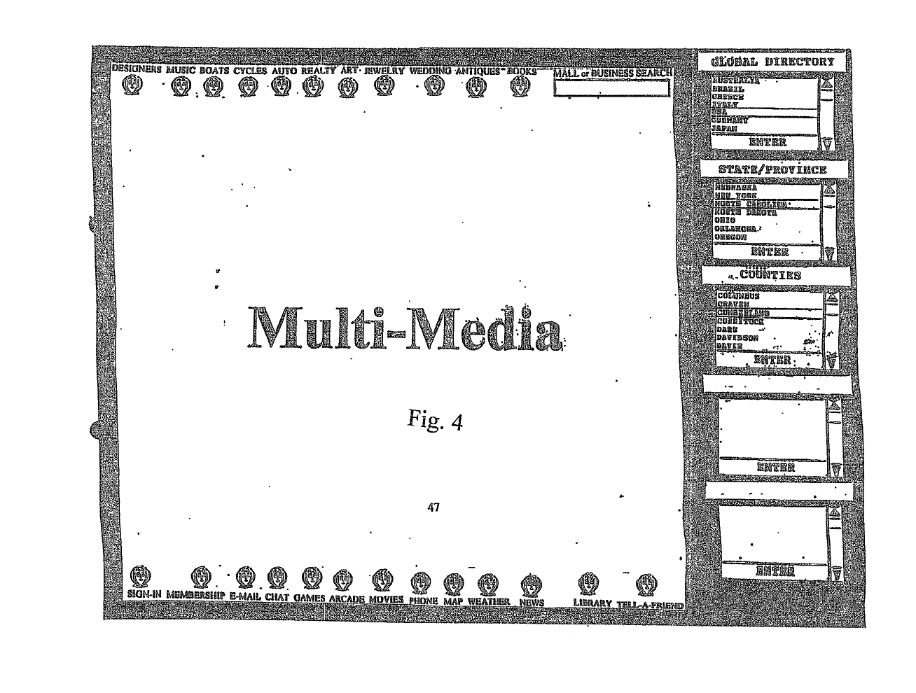

In operation, the system is initialized, for example, by a user approaching the kiosk 110 and requesting specific information. For example, a user enters, via input device 140, a request for product and/or services. This entry of product and/or service information can be, for example, a free form search, or, alternatively, a customized search where the user is directed, for example, by locality information, by product type, by information type, or the like, to a particular product. For example, FIGS. 2-11 illustrate an exemplary tailored search where a user is directed through geographical restrictions and then by product category to the desired product. For example, in FIG. 2, the user selects a country. Next, in FIG. 3, the user selects a particular state within that country. Then, a user selects a county within that state in FIG. 4.

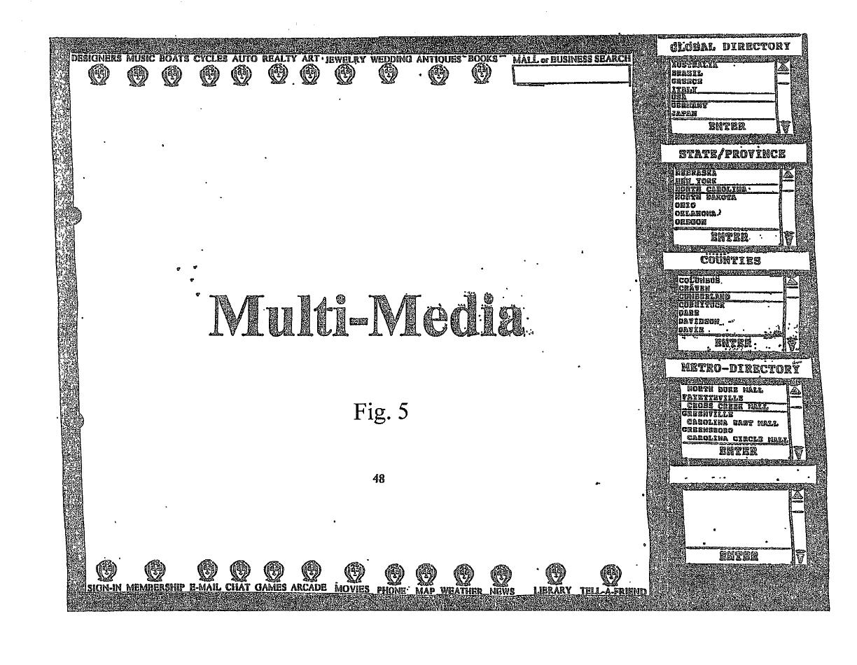

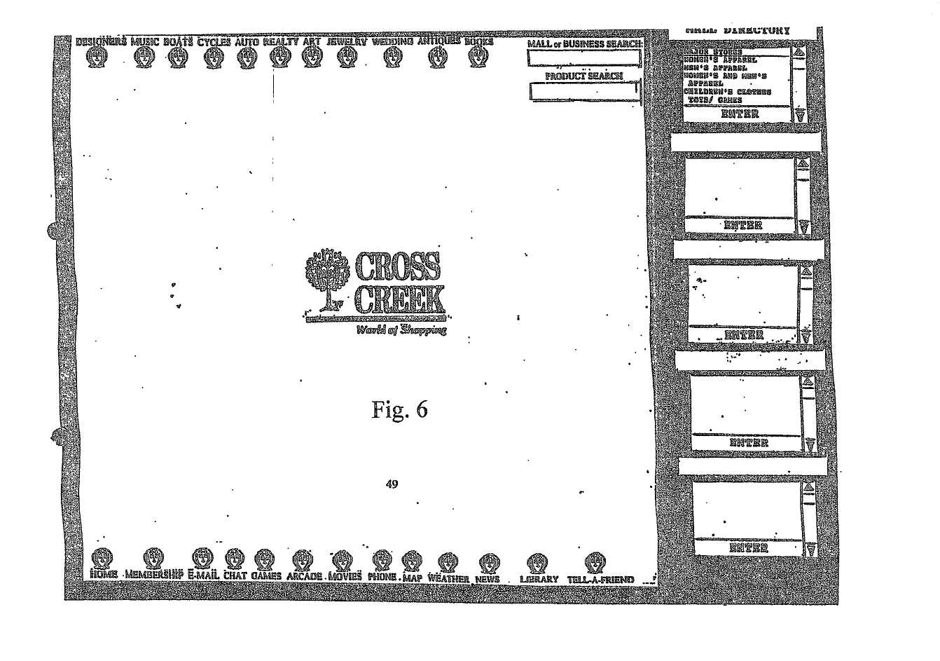

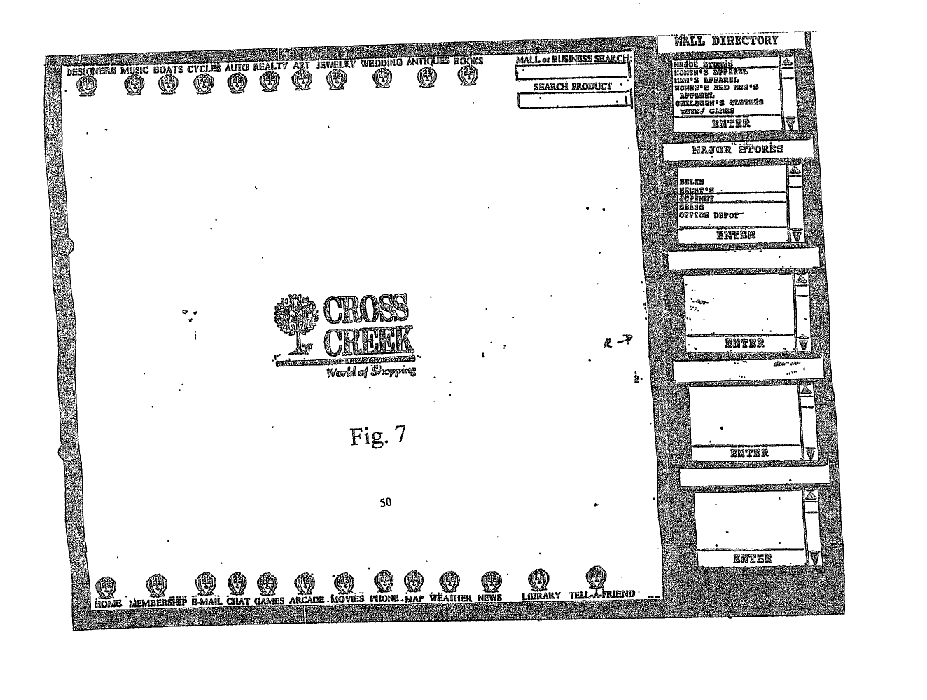

A user then selects, for example as illustrated in FIG. 5, a particular mall within that county. Next, a user, for example as illustrated in FIG. 6, selects a category of store within the selected mall. Then, as illustrated in FIG. 7, a user selects a particular department store.

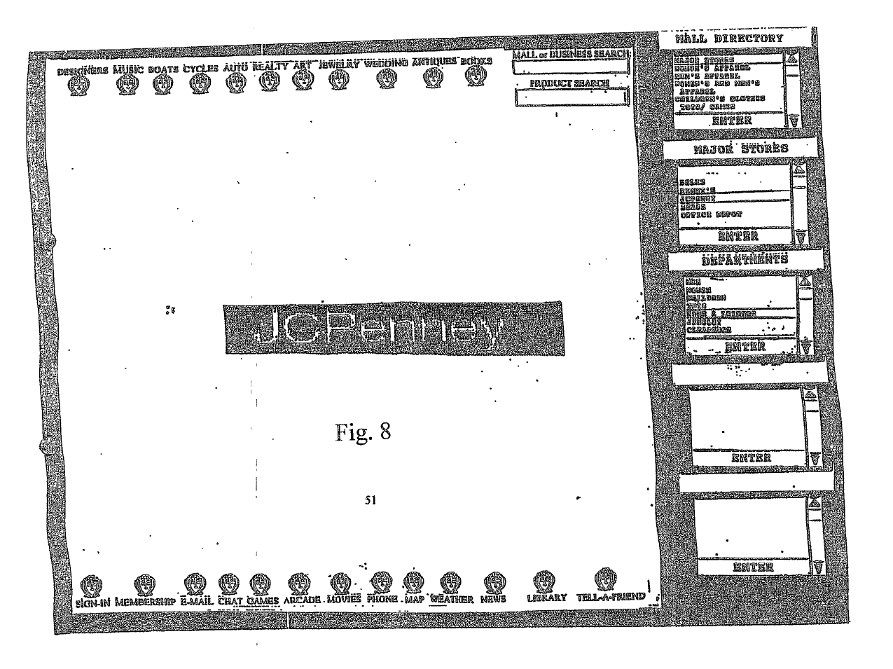

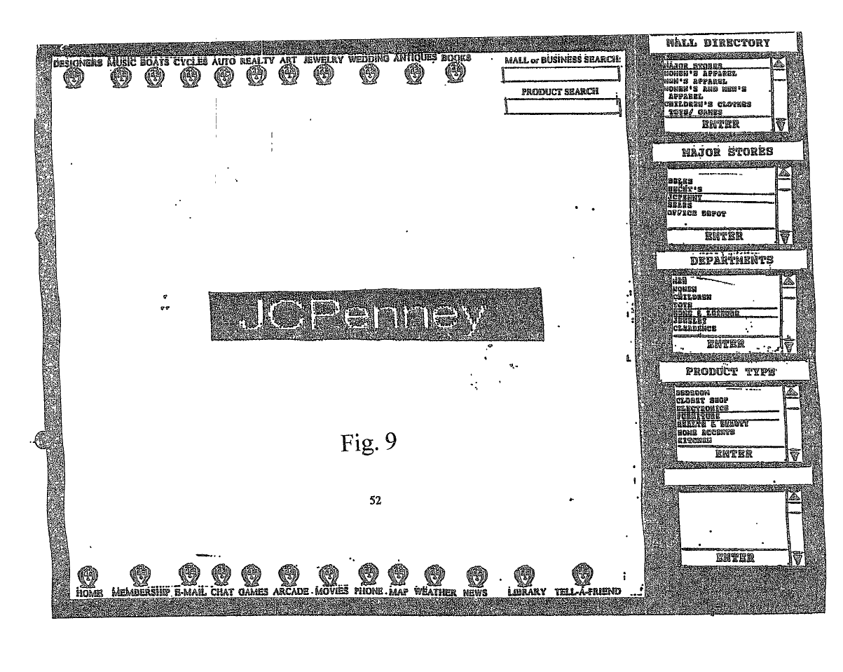

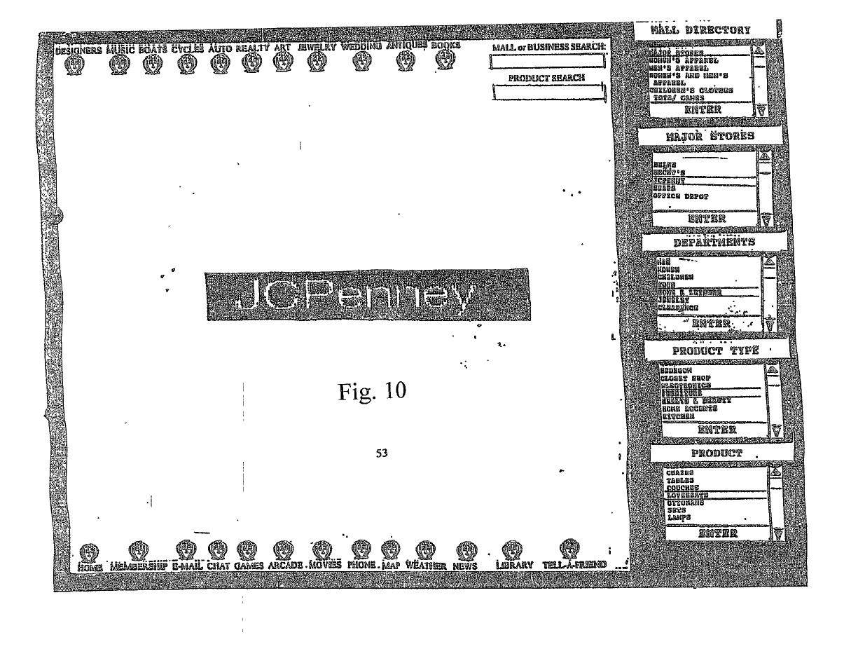

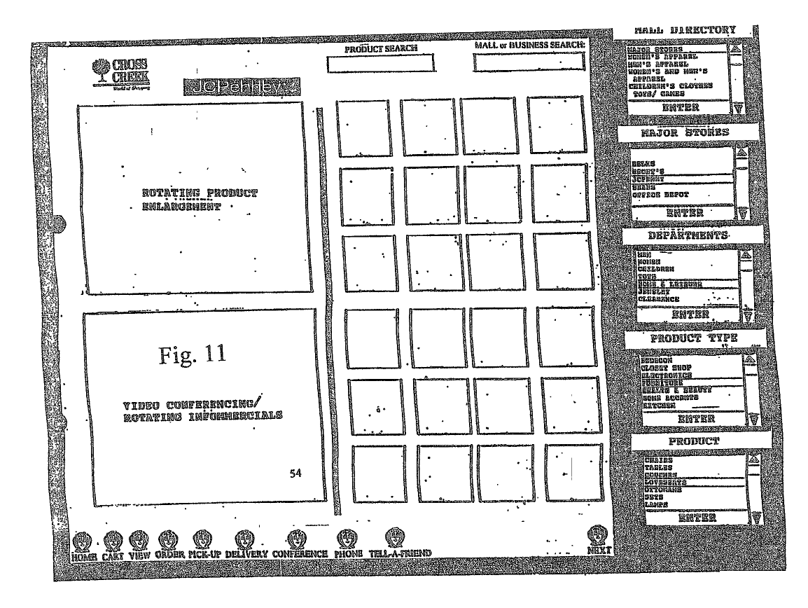

A user then selects a department as illustrated in FIG. 8. Then, a user selects a product type within that department as illustrated in FIG. 9. Then, as illustrated in FIG. 10, a user selects a product category. As illustrated in FIG. 11, a graphical user interface is assembled illustrating the products available based on the user's targeted search.

Alternatively, if a user possesses the various information beforehand, the user can, for example, enter an advanced search directly which could, for example, include the necessary search parameters that would result in locating the desired product. Alternatively still, the user interfaces that assist a user in locating one or more of a product/service can be tailored in any manner that assists the user.

For example, the kiosks 110 can employ a proprietary broadcasting technology. This technology could allow, for example, a user to track up to the minute broadcast video feeds from any source in the world, which could, for example, be identified as an additional advertising source for funding of free phone service. For example, a user in Virginia can initialize the system in search of a local news broadcast from North Carolina by selecting “News” from the user interface. A user would then select from a global directory of the United States the state, county, city and so forth, until the desired local broadcast station is located. A user could then make a selection and select from the local broadcast station's product showcase. For example, the user could select a category such as crime, weather, news headline, sports, or the like. Upon selection of a category, the broadcast is initiated which can be displayed on the display device or, for example, forwarded to a particular destination, such as the user's home.

Thus, the kiosk 110, upon receipt of the product/service information request, forwards the request, via link 5 and one or more distributed networks 10, to a product/server database 300. The product/server database 300 queries one or more of the data server appliance 310 and the application server appliance 320 to locate the requested information. The product/server database 300 can operate in a similar manner to commercially available search engines. Furthermore, the database service appliance 310 and the application server appliance 320 could be implemented as servers running, for example, commercially available search engine software. Therefore, the kiosks 110 are able to manage the convergence of voice, video and data over one or more distributed networks.

Upon locating information pertaining to the requested product/service, the product/service database 300, forwards, via link 5 and one or more distributed networks 10, the results of the search to the kiosk 110, the kiosk 110 receives, via network interface 120, the results of the search and displays, on display device 130, the results. A user can then, for example, request additional information about the search or products/service, or alternatively, establish a voice communication via the voice-intelligent phone 200, and the aid of the network interface 210 and the display device 220, with, for example, the retailer. The retailer could then, for example, provide additional information about the product/service or, for example, provide real-time inventory information, or, for example, an explanation of how the product works. For example, a retailer could, for example, use a video camera as an input device and transmit real time images of product information to a user located at kiosk 110. This real time video information could then, for example, be displayed on display device 130.

Additionally, the kiosk 110 receives one or more information streams than can be, for example, displayed on display device 130, or one or more other display devices (not shown) there are associated with the kiosk 110. One or more of these display devices can display, for example, advertising information, news feeds, television broadcasts, or any other type of digital audio/video information. The information for supplying these displays is forwarded, via links 5 and one or more distributed networks 10, from broadcast server 400 with the aid of the advertising server 420, and/or the video content server 410. Alternatively, information can be provided from one or more digital information providers 500, via link 5, and the distributed network 10. Accordingly, depending on the type of information displayed on one or more of the display devices 130, the information can come from one or more of the video content server 410, the advertising server 420, and the digital information providers 500.

The voice-intelligent phone 200, in cooperation with the POTS 600, VOIP 610, and one or more distributed networks 10 and links 5, manages and controls voice communications between one or more parties, this can be a direct party-to-party communication, a PC to PC connection, a PC to phone connection, or, for example, an audio/video teleconference. The voice-intelligent phone system can operate, for example, using standard voice over internet protocol technology. Additionally, the voice intelligent phone 200 can run an operating system, such as Windows® CE, that allows for application layers such that phone directories, or the like can be displayed on the display device 220. Furthermore, the input device 230 can be a wired or wireless handset that can have embedded remote control buttons that can provide users access to digital television and special program services, whose revenues can also be used, for example, to fund the free phone service. Additionally, the voice intelligent phone can display advertising that is designed, for example, to subsidize connection fees imposed by, for example, a connection provider, thus reducing or eliminating the end user's monthly bill.

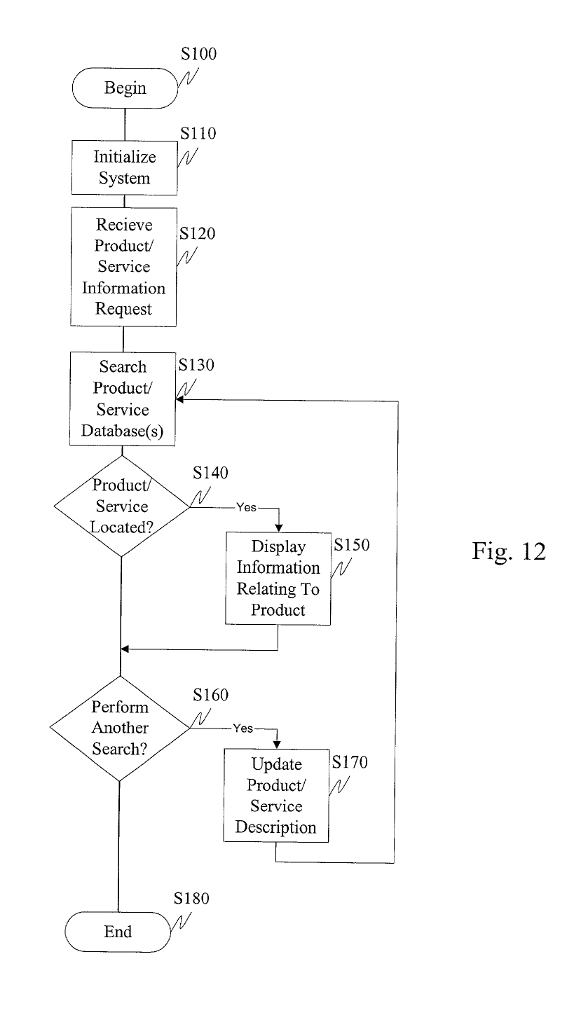

FIG. 12 illustrates an exemplary method for searching a product/service in accordance with an exemplary embodiment of the invention. In particular, control begins in step S100 and continues to step S110. In step S110, the system is initialized. Next, in step S120, a product/service information request is received. Then, in step S130, a search for the requested product/service is conducted. Control then continues to step S140.

In step S140, a determination is made whether the requested product/service has been located. If the requested product/service has been located, control continues to step S150. Otherwise, control jumps to step S160.

In step S150, information relating to the requested products/services is displayed. Control then continues to step S160.

In step S160, a determination is made whether to perform another search. If another search is to be performed, control continues to step S170. Otherwise, control jumps to step S180 where the control sequence ends.

In step S170, a user can update the request for a product/service. Control then continues back to step S130 where the search for the requested product/service is conducted.

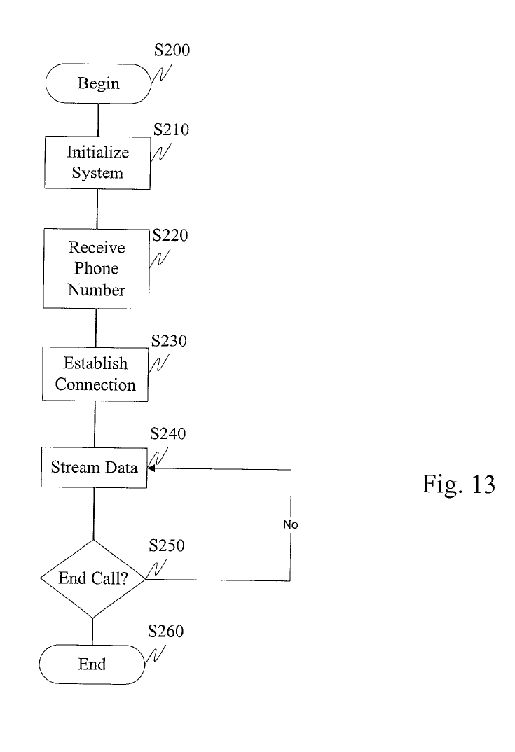

FIG. 13 illustrates an exemplary method of establishing communication via the voice-intelligent phone. In particular, control begins in step S200 and continues to step S210. In step S210, the system is initialized. Next, in step S220, one or more phone numbers are input to the voice-intelligent phone. The voice-intelligent phone, in cooperation with, for example, a voice-intelligent phone stream server, establishes a connection in step S230 with the one or more parties identified in step S220. Control then continues to step S240.

In step S240, data from the various parties is streamed and distributed. Next, in step S250, a query is made whether to end the call. If the call is to be terminated, control continues to step S260 where the sequence ends. Otherwise, control returns to step S240 where the audio/video data is continued to be streamed.

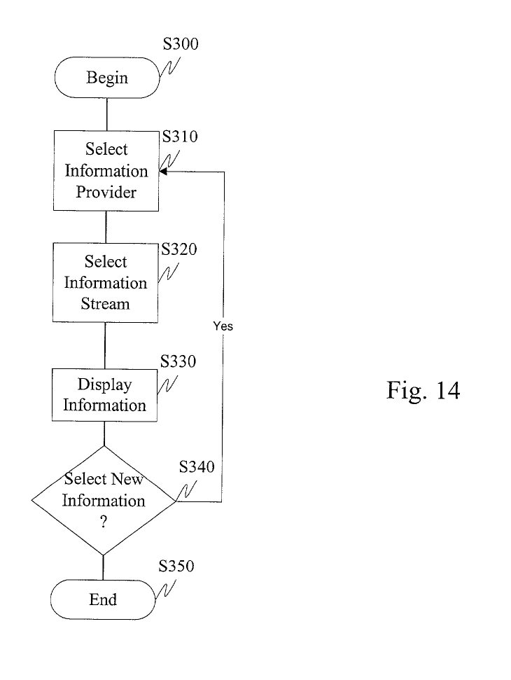

FIG. 14 illustrates an exemplary method of selecting information that could, for example, be displayed on one or more of the display devices 130 or 220. In particular, control begins in step S300 and continues to step S310. In step S310, an information provider is selected. Next, in step S320, an information stream is selected. Then, in step S330, the selected information is displayed. Control then continues to step S340.

In step S340, a determination is made whether new information should be selected. If new information is to be selected, control jumps back to step S310. Otherwise, control continues to step S350 where the control sequence ends.

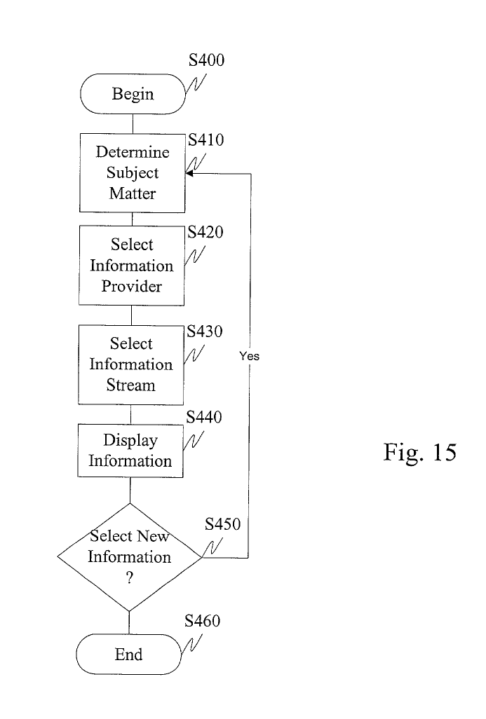

FIG. 15 illustrates an exemplary method of determining an information provider based on one or more criteria. In particular, control begins in step S400 and continues to step S410. In step S410, the subject matter of, for example, the product/server inquiry is determined. Alternatively, subject matter can be determined, for example, based on the geographical location, environment, time of day, or the like of the kiosk 110. Next, in step S420, an information provider is selected based on the determined subject matter. Then, in step S430, an information stream from the selected information provider is selected. Control then continues to step S440. In step S440, the selected information is displayed. Next, in step S450, a determination is made whether new information should be selected. If new information is to be selected, control jumps back to step S410. Otherwise, control continues to step S460 where the control sequence ends.

As shown in FIG. 1, the electronic commerce system is implemented either on a single program general purpose computer, or a separate programmed general purpose computer. However, the electronic commerce system can also be implemented on a special purpose computer, a programmed microprocessor or microcontroller and peripheral integrated circuit element, an ASIC or other integrated circuit, a digital signal processor, a hard wired electronic or logic circuit such as a discrete element circuit, a programmable logic device such as a PLD, PLA, FPGA, PAL, or the like. In general, any device capable of implementing a finite state machine that is in turn capable of implementing the flow charts illustrated in FIGS. 12-15 can be used to implement the electronic commerce system according to this invention.

Furthermore, the disclosed method may be readily implemented in software using object or object-oriented software development environments that provide portable source code that can be used on a variety of computer or workstation hardware platforms. Alternatively, the disclosed electronic commerce system can be implemented partially or fully in hardware using standard logic circuit or VLSI design. Whether software or hardware is used to implement the systems in accordance with this invention, is dependent on the speed and/or efficiency requirements of the system, the particular function, and the particular software or hardware systems or microprocessor or microcomputer systems being utilized. The electronic commerce system and methods illustrated herein however, can be readily implemented in hardware and/or software using any known or later developed systems or structures, devices and/or software by those of ordinary skill in the applicable art from the functional description provided herein and with the general basic knowledge of the computer and telecommunications arts.

Moreover, the disclosed methods may be readily implemented as software executed on a programmed general purpose computer, a special purpose computer, a microprocessor, or the like. In these instances, the methods and systems of this invention can be implemented as a program embedded on a personal computer such as a Java® or a CGI script, as a resource residing on a server or a graphics workstation, as a routine embedded in an electronic commerce system, a web browser, an electronic commerce enabled cellular telephone, a PDA, a dedicated electronic commerce management system, or the like. The electronic commerce system can also be implemented by physically incorporating the system into a software and/or hardware system, such as the hardware and software of a graphics workstation or dedicated electronic commerce management system.

It is, therefore, apparent that there has been provided, in accordance with the present invention, systems and methods for electronic commerce. While this invention has been described in conjunction with a number of embodiments, it is evident that many alternatives, modifications and variations would be or are apparent to those of ordinary skill in the applicable arts. Accordingly, it is the intent to embrace all such alternatives, modifications, equivalents and variations that are within the spirit and scope of this invention.

What is claimed is:

1. An electronic commerce system comprising:
an interface that allows a user to retrieve information about one or more of products and services; and
one or more information servers that communicate with the interface to supply the information, wherein access to the interface is provided to the user free of charge.

2. The system of claim 1, wherein the interface is subsidized through the use of advertising.

3. The system of claim 2, wherein the advertising is displayed on the interface.

4. The system of claim 3, wherein the advertising is at least one of digital audio, digital video and multimedia.

5. The system of claim 1, wherein the user is provided with a search interface that assists the user in locating one or more of the products and services.

6. The system of claim 1, further comprising a telephone system allowing a user to communicate with one or more additional parties using a voice over internet protocol.

7. A method for conducting electronic commerce comprising:
retrieving information about one or more of products and services; and
communicating with the interface to supply the information, wherein access to the interface is provided to the user free of charge.

8. The method of claim 7, wherein the interface is subsidized through the use of advertising.

9. The method of claim 8, wherein the advertising is displayed on the interface.

10. The method of claim 9, wherein the advertising is at least one of digital audio, digital video and multimedia.

11. The method of claim 7, wherein the user is provided with a search interface that assists the user in locating one or more of the products and services.

12. The method of claim 7, further comprising a telephone system allowing a user to communicate with one or more additional parties using a voice over internet protocol.

13. The method of claim 7, wherein the information is obtained from one or more of a voice network, a broadcast network, an information access network and an advertising network, wherein the networks are all accessible though the interface that is available to one or more users free of charge.

14. A method of conducting business comprising:
allowing a user to retrieve information about one or more of products and services via a distributed network; and
supplying the information to the user, wherein access to an interface allowing retrieval of the information is provided to the user free of charge.

15. The method of claim 1, wherein the interface is subsidized through the use of advertising.

16. The method of claim 15, wherein the advertising is displayed on the interface.

17. The method of claim 16, wherein the advertising is at least one of digital audio, digital video and multimedia.

18. The method of claim 14, wherein the user is provided with a search interface that assists the user in locating one or more of the products and services.

19. The method of claim 14, further comprising a telephone system allowing a user to communicate with one or more additional parties using a voice over internet protocol.
